(19) United States
(12) Patent Application Publication
(10) Pub. No.: US 2013/0332370 A1
(43) Pub. Date: Dec. 12, 2013

(54) REPLACEABLE BATTERY VALUATION SYSTEM

(71) Applicants: Roderick A. Hyde, Redmond, WA (US); Jordin T. Kare, Seattle, WA (US); Thomas A. Weaver, San Mateo, CA (US)

(72) Inventors: Roderick A. Hyde, Redmond, WA (US); Jordin T. Kare, Seattle, WA (US); Thomas A. Weaver, San Mateo, CA (US)

(73) Assignee: Searete LLC, a limited liability corporation of the State of Delaware

(21) Appl. No.: 13/490,160

(22) Filed: Jun. 6, 2012

(51) Int. Cl. G06Q 30/00

(52) U.S. Cl. 705/306

(57) ABSTRACT

A replaceable battery valuation system may include, but is not limited to: at least one replaceable battery module; at least one sensor configured to measure at least one characteristic of the at least one replaceable battery module; and a controller configured to determine a monetary value of at least one replaceable battery module based upon sensor data regarding the at least one characteristic of the at least one replaceable battery module and provide a notification regarding the monetary value.

### SUMMARY

A replaceable battery valuation system may include, but is not limited to: at least one replaceable battery module; at least one sensor configured to measure at least one characteristic of the at least one replaceable battery module; and a controller configured to determine a monetary value of at least one replaceable battery module based upon sensor data regarding the at least one characteristic of the at least one replaceable battery module and provide a notification regarding the monetary value.

In one or more various aspects, related systems include but are not limited to circuitry and/or programming for affecting the herein referenced aspects; the circuitry and/or programming can be virtually any combination of hardware, software, and/or firmware configured to effect the herein referenced method aspects depending upon the design choices of the system designer.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

FIG. 1 shows a high-level illustration of an exemplary system for replaceable battery valuation.

FIG. 2 shows a high-level illustration of an operational environment.

FIG. 3 shows a high-level illustration of an exemplary system for replaceable battery valuation; and

FIGS. 4-14 show operations associated with a method for replaceable battery valuation.

### DETAILED DESCRIPTION

With the development of batteries having ever-increasing power and storage capacities combined with the proliferation of mobile devices (e.g. smart phones, tablet computers, laptop computers, automobiles, etc.) employing such batteries, battery replacement/exchange services may be needed to provide users with replacement batteries when performance characteristics of in-use batteries are insufficient for their intended use. In order for a user to efficiently and cost effectively replace/exchange their used batteries, systems and methods for replaceable battery valuation are described herein.

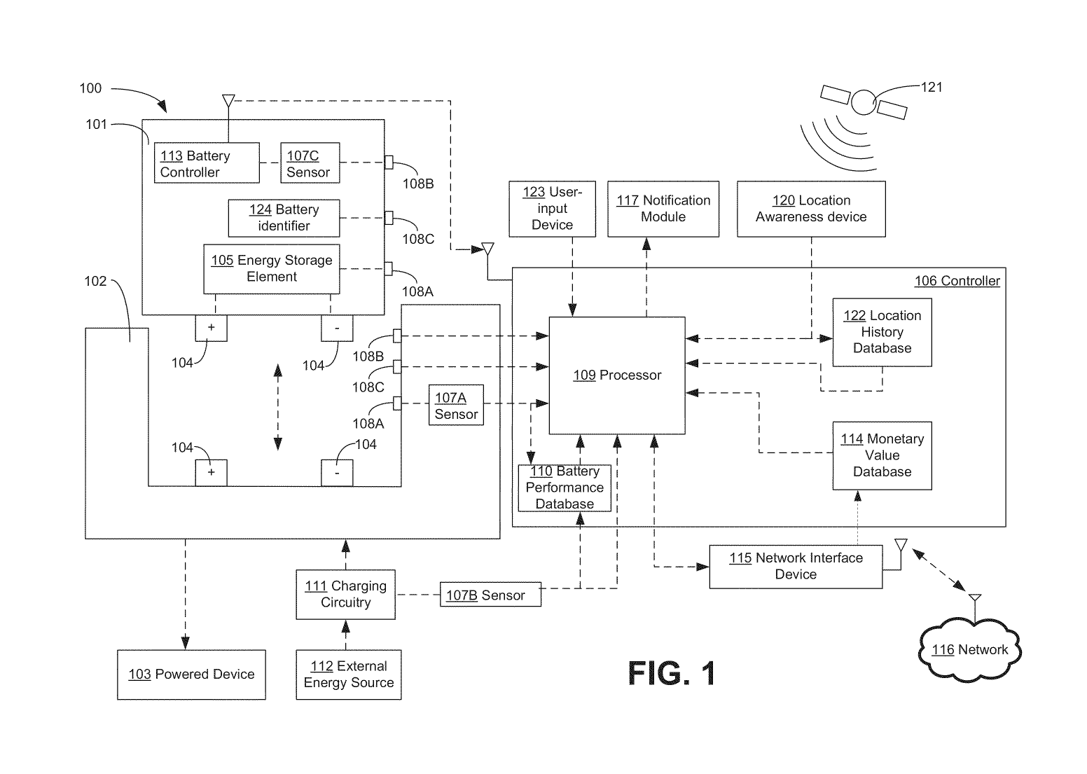

Referring to FIG. 1, a replaceable battery valuation system 100 is illustrated. The replaceable battery valuation system 100 may include a replaceable battery module 101 that may be received by a replaceable battery module compartment 102. The replaceable battery module compartment 102 may be integrated into and/or operably coupled to a powered device 103 (e.g. an automobile, smart phone, tablet computer, laptop computers, etc.). The replaceable battery module 101 may interface with the replaceable battery module compartment 102 through one or more contacts 104 to provide energy from an energy storage element 105 (e.g. a capacitive storage element, an electrochemical storage element, a fuel cell element, etc.) of the replaceable battery module 101 to the powered device 103 via the replaceable battery module compartment 102.

As referenced above, it may be desirable for a user needing replacement of a degraded replaceable battery module 101 to make the replacement in an efficient and cost effective manner. As such, the replaceable battery valuation system 100 may further include a controller 106 configured to determine a monetary value of the replaceable battery module 101 follow a period of use. For example, the replaceable battery valuation system 100 may include one or more sensors 107 configured to measure at least one characteristic of the replaceable battery module 101. For example, the replaceable battery module compartment 102 may include a sensor 107A configured to measure at least one characteristic of the replaceable battery module 101. The sensor 107A may be coupled to the energy storage element 105 of the replaceable battery module 101 when the replaceable battery module 101 is received within the replaceable battery module compartment 102 via at least two cooperating data transmission contacts 108A. The sensor 107A may detect one or more characteristics (e.g. a discharge voltage level, discharge current level, storage capacity, charge depth, temperature, etc.) of the replaceable battery module 101 and provide data associated with those characteristics to a processor 109 for further analysis. Alternately, the controller 106 may include a memory element configured to maintain a battery performance database 110 including performance data associated with the replaceable battery module 101 detected by the sensor 107A over a period of time (e.g. a peak discharge voltage, peak discharge current, average discharge voltage, average discharge current, number of charge cycles, average storage capacity, average charge hold depth, average temperature, etc.). The processor 109 may obtain the battery characteristic data from the battery performance database 110.

In another exemplary embodiment, the replaceable battery valuation system 100 a sensor 107B may be coupled to charging circuitry 111 operably coupling the replaceable battery module 101 to an external energy source 112 (e.g. a power utility grid) to recharge the replaceable battery module 101 when the replaceable battery module 101 is received within the replaceable battery module compartment 102. The sensor 107B may detect one or more characteristics (e.g. recharge voltage level, recharge current level, etc.) of the replaceable battery module 101 and provide data associated with those characteristics to the processor 109 for further analysis. Alternately, the controller 106 battery performance database 110 may store data associated with the replaceable battery module 101 detected by the sensor 107A over a period of time (e.g. a peak recharge voltage, peak recharge current, average recharge voltage, average recharge current, number of charge cycles, average storage capacity, average charge hold depth, average temperature, etc.).

In another embodiment, at least one sensor 107C may be embedded in the replaceable battery module 101. The sensor 1070 may detect one or more characteristics (e.g. individual cell voltage levels) of the energy storage element 105. The sensor may provide data to the controller 106 via data transmission contacts 108B.

In still another embodiment, the replaceable battery module 101 may incorporate a battery controller 113. The battery controller 113 may be operable to provide data from the embedded sensor 107C to the system controller 106 via a wired or wireless digital connection. The battery controller 113 may also be configured to store information on the operating history of the replaceable battery module 101, including historical sensor data for the sensor 1070 such as number of charge/discharge cycles, etc.

Upon detection of battery characteristic data associated with the replaceable battery module 101, the processor 109 may obtain that battery characteristic data from a sensor 107 and/or the battery performance database 110 and employ that battery characteristic data to determine a monetary value associated with the replaceable battery module 101 and provide a notification associated with that determined monetary value to a user so as to allow the user to decide whether or not to replace the replaceable battery module 101.

For example, as shown in FIG. 1, the controller 106 may further include a memory element configured to maintain a monetary value database 114. The monetary value database 114 may store data associated with a monetary value (e.g. a monetary credit which may be earned upon surrender of the replaceable battery module 101) of a replaceable battery module 101 having various performance characteristics. For example, the monetary value database 114 may maintain a “charge cycles vs. monetary value” table where an increasing number of charge cycles for a replaceable battery module 101 (indicative of degradation of the replaceable battery module 101) corresponds to a decreasing monetary value of the replaceable battery module 101. Such tables may be maintained for any number of performance characteristics associated with the replaceable battery module 101.

In order to determine a monetary value of a replaceable battery module 101 currently received within the replaceable battery module compartment 102 and operably coupled to the controller 106, the processor 109 may obtain battery characteristic data from a sensor 107 and/or the battery performance database 110 and perform a comparison with the monetary value data maintained in the monetary value database 114. For example, the processor 109 may obtain “recharge current” data from the sensor 107 and/or the battery performance database 110 and compare that “recharge current” data to the various “recharge current” valuation levels maintained in the monetary value database 114 in order to select a monetary value for replaceable battery module 101 having those “recharge current” characteristics.

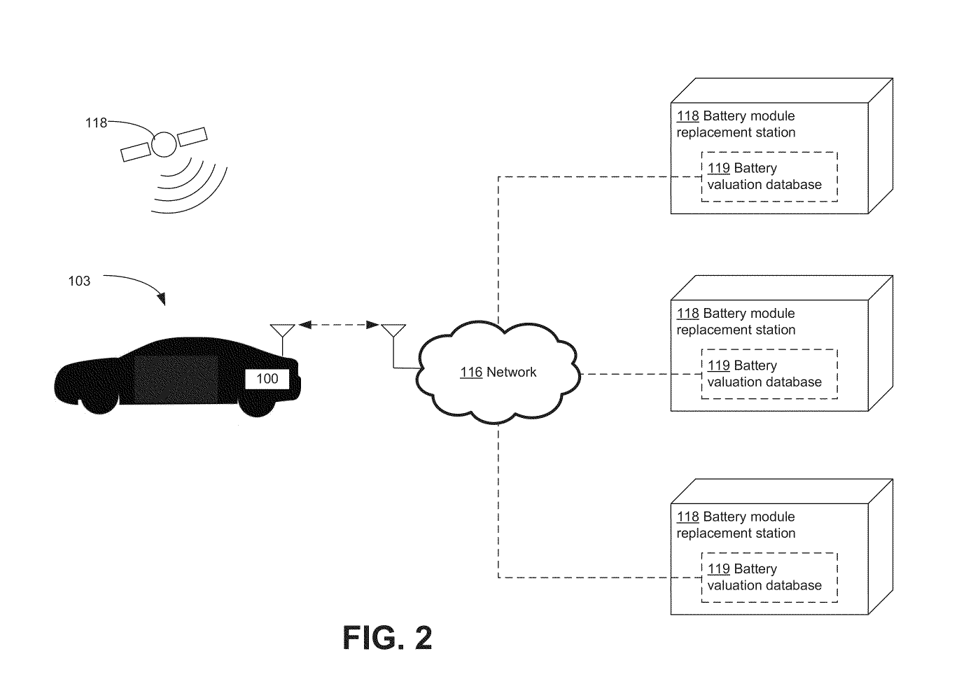

The processor 109 may also obtain either battery performance database information or monetary value information from an external source. For example, as shown in FIGS. 1 and 2, the replaceable battery valuation system 100 may further include a network interface device 115 (e.g. a wireless communications device employing GSM, GPRS, CDMA, EV-DO, EDGE, WiMAX, LTE and or Wi-fi protocols, and the like) to communicate with a communications network 116 which provides access to data, e.g., via the Internet. Such data may be publicly accessible, or may be provided only to specific users, e.g., customers of a valuation service, in which case the network interface device 115 may provide authentication or encryption/decryption capabilities needed to use the service.

More specifically, the processor 109 may determine a rate of change of the monetary value associated with the replaceable battery module 101 over a period of time. For example, the processor 109 may obtain battery characteristic data from a sensor 107 and/or the battery performance database 110 over time and perform multiple comparisons with the monetary value data maintained in the monetary value database 114. The result of each comparison (e.g. a current monetary value associated with the replaceable battery module 101) may be stored to the monetary value database 114. After a number of such comparisons, the processor 109 may retrieve two or more monetary values associated with the replaceable battery module 101 and compute a rate of change of the monetary values associated with the replaceable battery module 101 according to the monetary values associated with the replaceable battery module 101 and a time interval between the computation of those monetary values associated with the replaceable battery module 101.

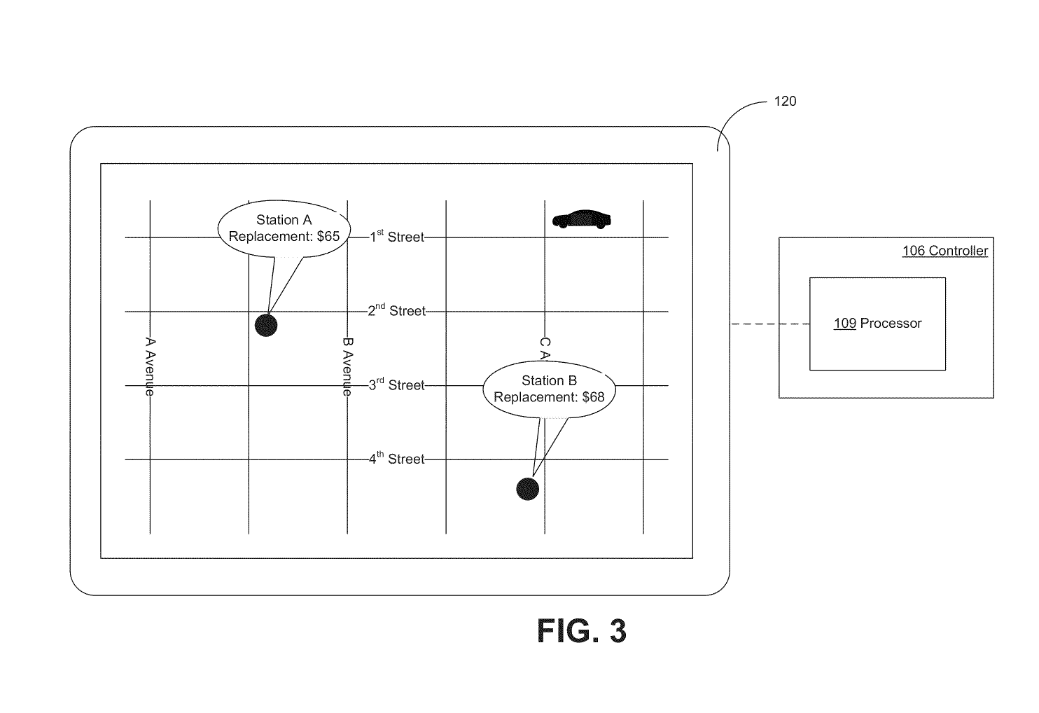

In another exemplary embodiment, as shown in FIGS. 2 and 3, the replaceable battery valuation system 100 may include a notification module 117 (e.g. an audio/video interface device such as a LCD monitor/touch screen). The notification module 117 may receive one more audio/video signals associated with replaceable battery valuation information associated with the replaceable battery module 101 from the processor 109 and provide that information to a user. For example, described above, the replaceable battery valuation system 100 may determine its location relative to one or more battery module replacement stations 118. The processor 109 may access a maps database (not shown) and provide signals to the notification module 117 causing the notification module 117 to display a graphical map including indicators associated with the locations of the replaceable battery valuation system 100 and the battery module replacement stations 118. In addition to the location of the battery module replacement stations 118, the notification module 117 may display battery replacement valuation information associated with each battery module replacement station 118 (e.g. as a call-out icon associated with the location of each battery module replacement station 118.)

Alternately, the processor 109 may cause the network interface device 115 to provide one or more notifications regarding the monetary valuation of the replaceable battery module 101 over the network 116. For example, the processor 109 may cause the network interface device 115 to transmit an e-mail to text message to a user's e-mail or text messaging account or post the monetary valuation of the replaceable battery module 101 to a web site accessible by the user.

In another exemplary embodiment, referring to FIG. 2, a network of battery module replacement stations 118 may be provided which provide battery replacement services to allow a user of a powered device 103 (e.g. a vehicle) to replace/exchange a degraded replaceable battery module 101. The user may receive a credit for the value of the replaceable battery module 101 (determined as described above) from a battery module replacement station 118 to be applied against a cost of a replacement replaceable battery module 101. It may be the case that each of the battery module replacement stations 118 may employ independent battery exchange credit/replacement cost valuation information associated with their battery exchange/replacement services. Such battery exchange/replacement valuation information may be maintained in a battery valuation database 119 associated with each battery module replacement station 118. In order to effectively value a replaceable battery module 101 according to valuation information of those battery module replacement stations 118 in proximity to a powered device 103 employing a replaceable battery module 101 so as to permit a user to choose between the battery module replacement stations 118, the battery valuation information maintained in the battery valuation database 119 of each battery module replacement station 118 may be obtained by the replaceable battery valuation system 100 to enable battery module replacement station 118—specific valuations for a replaceable battery module 101 currently in use.

The network interface device 115 of the replaceable battery valuation system 100 may interface with the network 116 to obtain battery valuation information from the battery valuation database 119 of each battery module replacement station 118. This battery valuation information may be stored to the monetary value database 114 of the replaceable battery valuation system 100. The processor 109 may then carry out replacement battery valuation operations, as described above, with respect to battery valuation information for each battery module replacement station 118, respectively.

In another exemplary embodiment, the replaceable battery valuation system 100 may further include a location awareness device 120 (e.g., a Global Positioning System (GPS) receiver configured to receive a GPS signal from one or more GPS satellites 121). The location awareness device 120 may be configured to determine a location of a powered device 103 employing the replaceable battery module 101 so as to locate one or more battery module replacement stations 118 in proximity to the powered device 103 such that those battery module replacement stations 118 may be provided to a user as potential options for replacement of a degraded replaceable battery module 101.

For example, as shown in FIG. 2, the replaceable battery valuation system 100 may determine its location relative to one or more battery module replacement stations 118 using the location awareness device 120. The processor 109 may obtain the location data from the location awareness device 120. Further, the processor 109 may obtain location data associated with various battery module replacement stations 118 (e.g. via network 116). The processor 109 may compare the location data associated with the replaceable battery valuation system 100 and the location data associated with the various battery module replacement stations 118 to determine a relative distance to the battery module replacement stations 118. The battery module replacement stations 118 may be filtered by distance to provide battery valuation information only for those battery module replacement stations 118 in proximity to the replaceable battery valuation system 100 (e.g. within a threshold distance from the replaceable battery valuation system 100 as determined from the relative locations of the replaceable battery valuation system 100 and the battery module replacement stations 118). The threshold distance may depend on one or more factors, e.g., for an electric vehicle, only battery module replacement stations within the driving range provided by the current battery charge level may be shown.

In another exemplary embodiment, the replaceable battery valuation system 100 may maintain a location history database 122. The location history database 122 may be configured to store historical location data as determined by the location awareness device 120 over a period of time. The processor 109 may periodically retrieve the historical location data and analyze the data for trends in the location history. For example, it may be the case that a user drives their vehicle along the same route to work Monday through Friday. Further, there may be multiple battery module replacement stations 118 along the route, each battery module replacement stations 118 having varying battery replacement/exchange valuation information. The processor 109 may determine that on a given day, a particular battery module replacement station 118 may have lower replacement pricing and/or higher exchange credits than other battery module replacement stations 118. Based on the a priori knowledge of the historical location data and the current battery replacement/exchange valuation information, the replaceable battery valuation system 100 may provide a predictive recommendation as to a specific battery module replacement station 118 that should be used for replacement of the replaceable battery module 101 when a characteristic of the replaceable battery module 101 indicates that replacement is needed (e.g. detection of a threshold level of degradation of the replaceable battery module 101 by a sensor 107).

In still another exemplary embodiment, referring again to FIG. 1, the replaceable battery valuation system 100 may include a user input device 123 (e.g. a keyboard, mouse, touch-screen, etc). The user input device 123 may be configured to receive one or more user inputs associated with one or more user-defined parameters related to replacement of the replaceable battery module 101. For example, a user may provide one or more inputs designating an intended route for a vehicle employing the replaceable battery valuation system 100. The processor 109 may obtain location and battery replacement valuation information associated with the battery module replacement stations 118 (as described above) along the user-inputted route and compute an optimized opportunity for replacement of the replaceable battery module 101 along that route based on the characteristics of the replaceable battery module 101.

In still another exemplary embodiment, the replaceable battery module 101 may include a battery identifier 124 (e.g. a bar code, radio frequency identifier, flash chip, etc.) associated with a class of replaceable battery modules 101 and/or a single replaceable battery module 101. When the replaceable battery module 101 is received within the replaceable battery module compartment 102, the processor 109 may interface with the battery identifier 124 (e.g. optically scan a bar code, wirelessly query an RFID, receive a signal associated with a stored identifier) via at least two data transmission contacts 1080 to obtain battery identification information stored by the battery identifier 124. The battery identification information may include information generic to a set of replaceable battery modules 101 including, but not limited to, battery type information, battery configuration information, battery manufacturer information, battery model number, and the like. The battery identification information may include information specific to a single replaceable battery module 101 including, but not limited to, a globally unique identifier (e.g. a serial number), manufacture date, certification data, and the like. In some embodiments, the function of the battery identifier 124 may be provided by the battery controller 113.

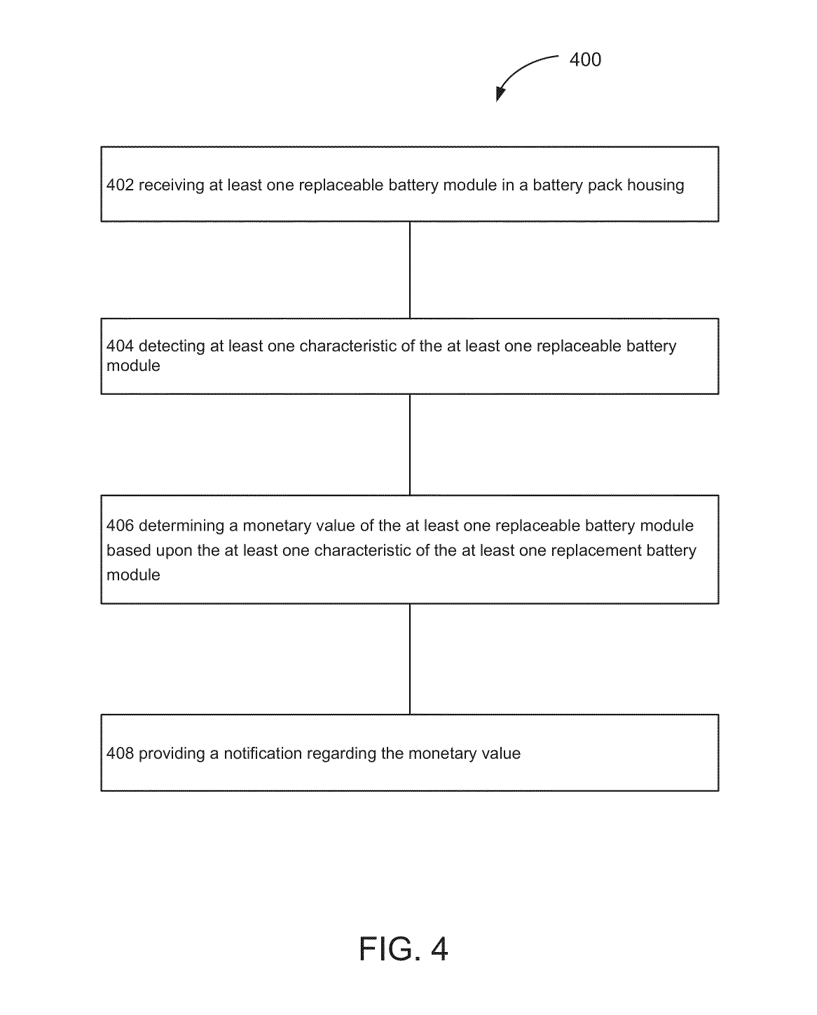

FIG. 4 and the following figures include various examples of operational flows, discussions and explanations may be provided with respect to the above-described exemplary environment of FIGS. 1-3. However, it should be understood that the operational flows may be executed in a number of other environments and contexts, and/or in modified versions of FIGS. 1-3. Also, although the various operational flows are presented in the sequence(s) illustrated, it should be understood that the various operations may be performed in different sequential orders other than those which are illustrated, or may be performed concurrently.

Further, in the following figures that depict various flow processes, various operations may be depicted in a box-within-a-box manner. Such depictions may indicate that an operation in an internal box may comprise an optional example embodiment of the operational step illustrated in one or more external boxes. However, it should be understood that internal box operations may be viewed as independent operations separate from any associated external boxes and may be performed in any sequence with respect to all other illustrated operations, or may be performed concurrently.

FIG. 4, illustrates an operational procedure 400 for practicing aspects of the present disclosure including operations 402, 404, 406 and/or 408.

Operation 402 illustrates receiving at least one replaceable battery module in a battery pack housing. For example, as shown in FIG. 1, the replaceable battery valuation system 100 may include a replaceable battery module 101 that may be received by a replaceable battery module compartment 102. The replaceable battery module compartment 102 may be integrated into and/or operably coupled to a powered device 125 (e.g. an automobile, smart phone, tablet computer, laptop computers, etc.). The replaceable battery module 101 may interface with the replaceable battery module compartment 102 through one or more contacts 104 to provide energy from an energy storage element 105 (e.g. a capacitive storage element, an electrochemical storage element, a fuel cell element, etc.) of the replaceable battery module 101 to the powered device 103 via the replaceable battery module compartment 102.

Operation 404 illustrates detecting at least one characteristic of the at least one replaceable battery module. For example, as shown in FIG. 1, the replaceable battery valuation system 100 may include one or more sensors 107 configured to measure at least one characteristic of the replaceable battery module 101. For example, the replaceable battery module compartment 102 may include a sensor 107A configured to measure at least one characteristic of the replaceable battery module 101. For example, the sensor 107A may be coupled to the energy storage element 105 of the replaceable battery module 101 when the replaceable battery module 101 is received within the replaceable battery module compartment 102. The sensor 107A may detect one or more characteristics (e.g. a discharge voltage level, discharge current level, storage capacity, charge depth, temperature, etc.) of the replaceable battery module 101 and provide data associated with those characteristics to a processor 109 for further analysis. Alternately, the controller 106 may include a memory element configured to maintain a battery performance database 110 including performance data associated with the replaceable battery module 101 detected by the sensor 107A over a period of time (e.g. a peak discharge voltage, peak discharge current, average discharge voltage, average discharge current, number of charge cycles, average storage capacity, average charge hold depth, average temperature, etc.). The processor 109 may obtain the battery characteristic data from the battery performance database 110.

In another exemplary embodiment, the replaceable battery valuation system 100 a sensor 107B may be coupled to charging circuitry 111 operably coupling the replaceable battery module 101 to an external energy source 112 (e.g. a power utility grid) to recharge the replaceable battery module 101 when the replaceable battery module 101 is received within the replaceable battery module compartment 102. The sensor 107B may detect one or more characteristics (e.g. recharge voltage level, recharge current level, etc.) of the replaceable battery module 101 and provide data associated with those characteristics to the processor 109 for further analysis. Alternately, the controller 106 battery performance database 110 may store data associated with the replaceable battery module 101 detected by the sensor 107A over a period of time (e.g. a peak recharge voltage, peak recharge current, average recharge voltage, average recharge current, number of charge cycles, average storage capacity, average charge hold depth, average temperature, etc.).

Upon detection of battery characteristic data associated with the replaceable battery module 101, the processor 109 may obtain that battery characteristic data from a sensor 107 and/or the battery performance database 110 and employ that battery characteristic data to determine a monetary value associated with the replaceable battery module 101 an provide a notification associated with that determined monetary value to a user so as to allow the user to decide whether or not to replace the replaceable battery module 101.

Operation 406 illustrates determining a monetary value of the at least one replaceable battery module based upon the at least one characteristic of the at least one replacement battery module. For example, as shown in FIG. 1, the controller 106 may further include a memory element configured to maintain a monetary value database 114. The monetary value database 114 may store data associated with a monetary value (e.g. a monetary credit which may be earned upon surrender of the replaceable battery module 101) of a replaceable battery module 101 having various performance characteristics. For example, the monetary value database 114 may maintain a “charge cycles vs. monetary value” table where an increasing number of charge cycles for a replaceable battery module 101 (indicative of degradation of the replaceable battery module 101) corresponds to a decreasing monetary value of the replaceable battery module 101. Such tables may be maintained for any number of performance characteristics associated with the replaceable battery module 101.

In order to determine a monetary value of a replaceable battery module 101 currently received within the replaceable battery module compartment 102 and operably coupled to the controller 106, the processor 109 may obtain battery characteristic data from a sensor 107 and/or the battery performance database 110 and perform a comparison with the monetary value data maintained in the monetary value database 114. For example, the processor 109 may obtain “recharge current” data from the sensor 107 and/or the battery performance database 110 and compare that “recharge current” data to the various “recharge current” valuation levels maintained in the monetary value database 114 in order to select a monetary value for replaceable battery module 101 having those “recharge current” characteristics.

Operation 408 illustrates providing a notification regarding the monetary value of the at least one replaceable battery module. For example, as shown in FIGS. 2 and 3, the replaceable battery valuation system 100 may include a notification module 117 (e.g. an audio/video interface device such as a LCD monitor/touch screen). The notification module 117 may receive one more audio/video signals associated with replaceable battery valuation information associated with the replaceable battery module 101 from the processor 109 and broadcast that information to a user. For example, described above, the replaceable battery valuation system 100 may determine its location relative to one or more battery module replacement stations 118. The processor 109 may access a maps database (not shown) and provide signals to the notification module 117 causing the notification module 117 to display a graphical map including indicators associated with the locations of the replaceable battery valuation system 100 and the battery module replacement stations 118. In addition to the location of the battery module replacement stations 118, the notification module 117 may display battery replacement valuation information associated with each battery module replacement station 118 (e.g. as a call-out icon associated with the location of each battery module replacement station 118.)

Alternately, the processor 109 may cause the network interface device 115 to provide one or more notifications regarding the monetary valuation of the replaceable battery module 101 of the over the network 116. For example, the processor 109 may cause the network interface device 115 to transmit an e-mail to text message to a user's e-mail or text messaging account or post the monetary valuation of the replaceable battery module 101 to a web site accessible by the user.

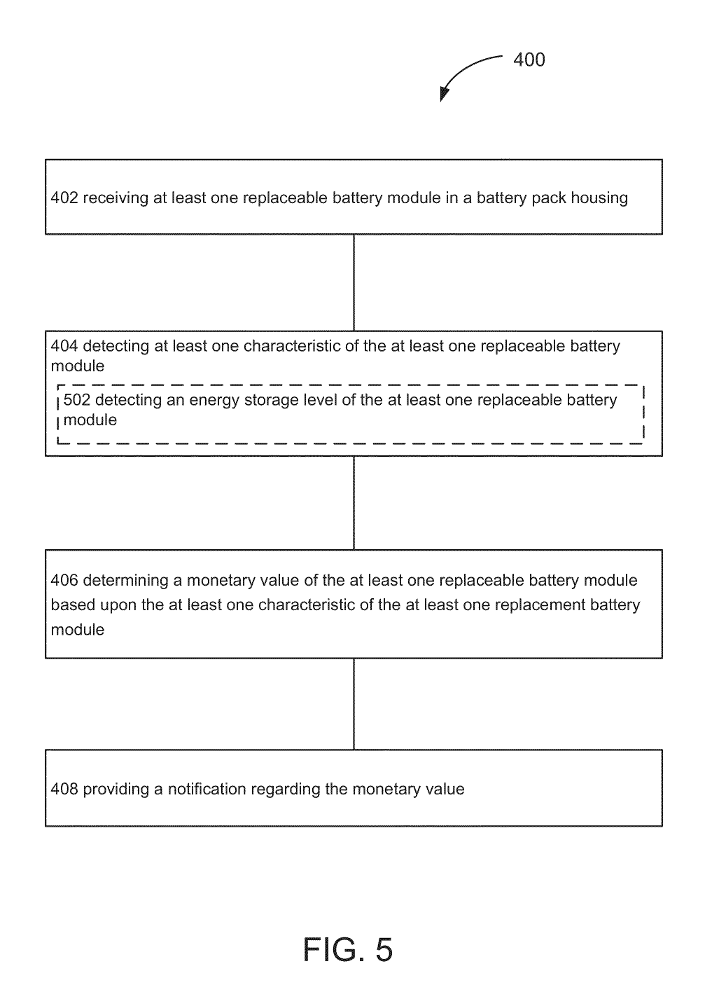

FIG. 5 illustrates an example embodiment where operation 404 of the example operational flow 400 of FIG. 4 may include at least one additional operation. Additional operations may include an operation 502.

Operation 502 illustrates detecting an energy storage level of the at least one replaceable battery module. For example, as shown in FIG. 1 in order to determine a monetary value of a replaceable battery module 101 currently received within the replaceable battery module compartment 102 and operably coupled to the controller 106, the processor 109 may obtain battery characteristic data from a sensor 107 and/or the battery performance database 110 and perform a comparison with the monetary value data maintained in the monetary value database 114. For example, the processor 109 may obtain energy storage level data (e.g. voltage level, charge level, etc.) from the sensor 107 and/or the battery performance database 110 and compare that energy storage level data to the various energy storage level valuation levels maintained in the monetary value database 114 in order to select a monetary value for replaceable battery module 101 having those energy storage level data characteristics.

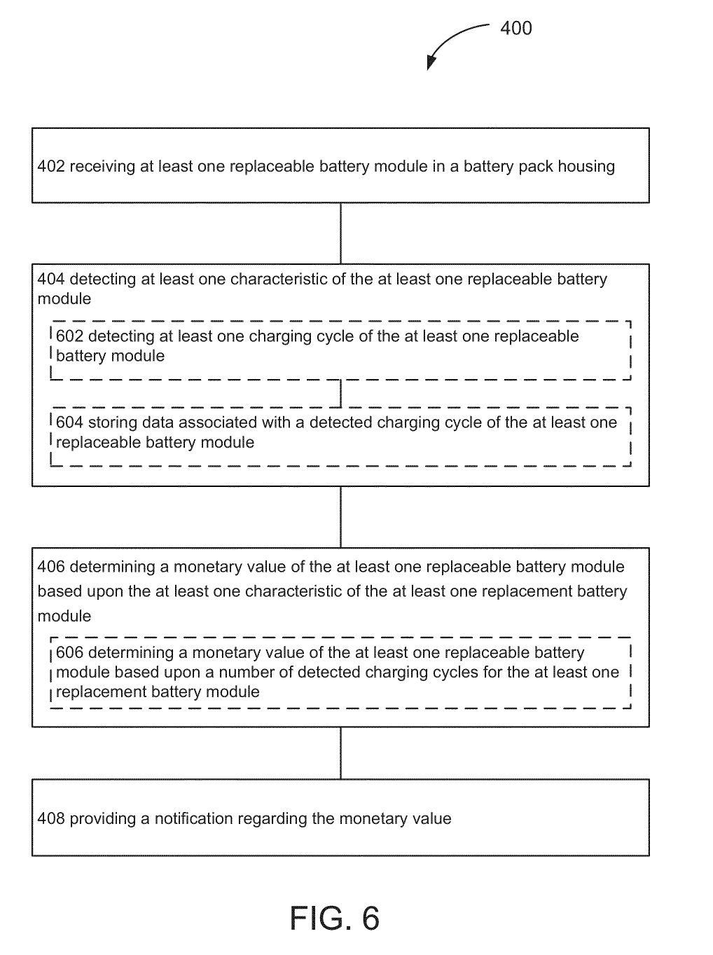

FIG. 6 illustrates an example embodiment where operation 404 of the example operational flow 400 of FIG. 4 may include at least one additional operation. Additional operations may include an operation 602 and/or 604. Further, FIG. 6 illustrates an example embodiment where operation 406 of the example operational flow 400 of FIG. 4 may include at least one additional operation. Additional operations may include an operation 606.

Operation 602 illustrates detecting at least one charging cycle of the at least one replaceable battery module. For example, as shown in FIG. 1 in order to determine a monetary value of a replaceable battery module 101 currently received within the replaceable battery module compartment 102 and operably coupled to the controller 106, the processor 109 may obtain battery characteristic data from a sensor 107 and/or the battery performance database 110 and perform a comparison with the monetary value data maintained in the monetary value database 114. For example, the sensor 107 may detect charging cycle data (e.g. voltage level, charge level, current level etc.) from the charging of the replaceable battery module 101 from the external energy source 112 via the charging circuitry 111.

Operation 604 illustrates storing data associated with a detected charging cycle of the at least one replaceable battery module. For example, as shown in FIG. 1, the charging cycle data may be stored to battery performance database 110. Over a period of time, the battery performance database 110 may track a number of occurrences of a charging cycle for the replaceable battery module 101.

Operation 606 illustrates determining a monetary value of the at least one replaceable battery module based upon a number of detected charging cycles for the at least one replacement battery module. For example, as shown in FIG. 1, the processor 109 may compare that charging cycle data stored in the battery performance database 110 to various charging cycle level valuation levels maintained in the monetary value database 114 in order to select a monetary value for replaceable battery module 101 having those charging cycle level data characteristics.

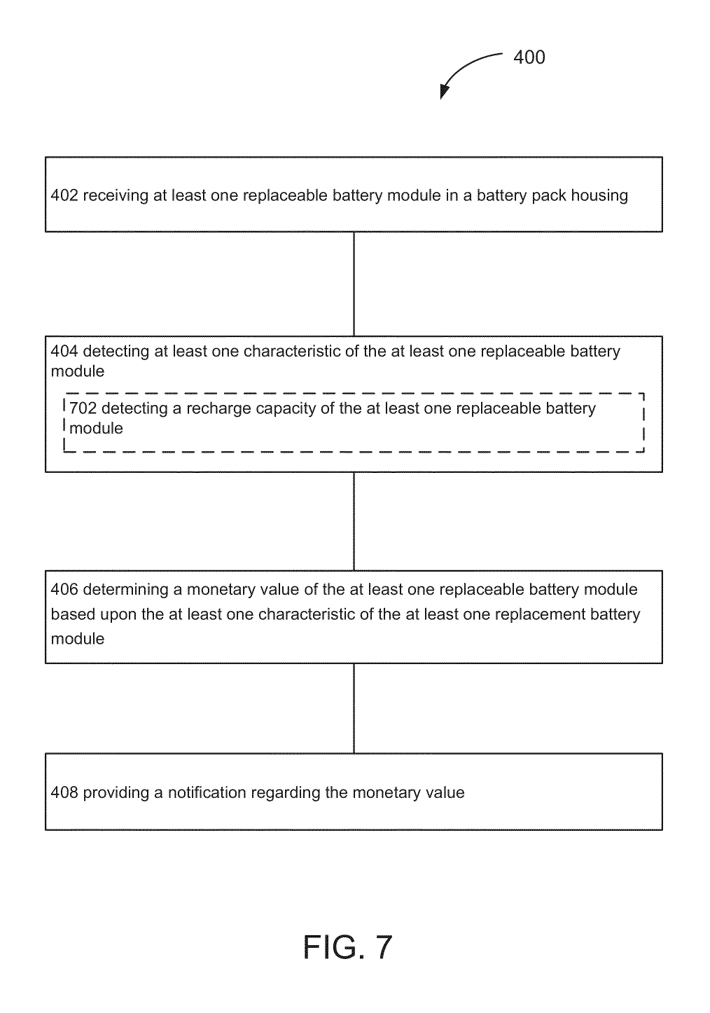

FIG. 7 illustrates an example embodiment where operation 404 of the example operational flow 400 of FIG. 4 may include at least one additional operation. Additional operations may include an operation 702.

Operation 702 illustrates detecting a recharge capacity of the at least one replaceable battery module. For example, as shown in FIG. 1, the processor 109 may obtain “recharge current” data from a sensor 107 and/or the battery performance database 110.

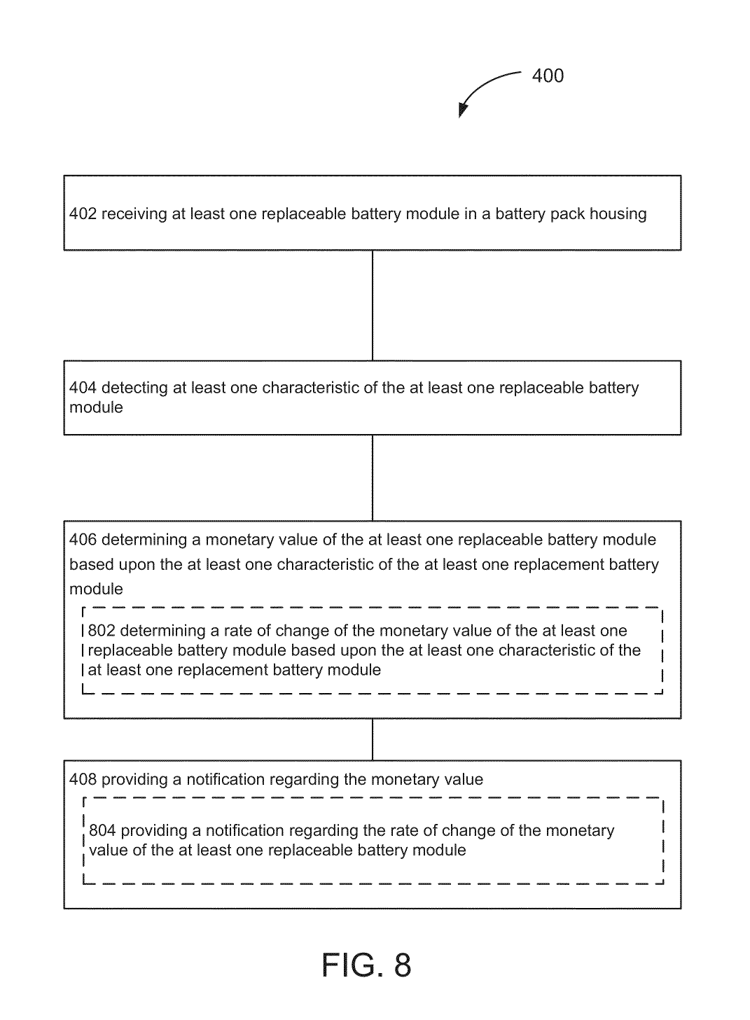

FIG. 8 illustrates an example embodiment where operation 406 of the example operational flow 400 of FIG. 4 may include at least one additional operation. Additional operations may include an operation 802.

Operation 802 illustrates determining a rate of change of the monetary value of the at least one replaceable battery module based upon the at least one characteristic of the at least one replacement battery module. For example, as shown in FIG. 1, the processor 109 may determine a rate of change of the monetary value associated with the replaceable battery module 101 over a period of time. For example, the processor 109 may obtain battery characteristic data from a sensor 107 and/or the battery performance database 110 over time and perform multiple comparisons with the monetary value data maintained in the monetary value database 114. The result of each comparison (e.g. a current monetary value associated with the replaceable battery module 101) may be stored to the monetary value database 114. After a number of such comparisons, the processor 109 may retrieve two or more monetary values associated with the replaceable battery module 101 and compute a rate of change of the monetary values associated with the replaceable battery module 101 according to the monetary values associated with the replaceable battery module 101 and a time interval between the computation of those monetary values associated with the replaceable battery module 101.

FIG. 8 further illustrates an example embodiment where operation 408 of the example operational flow 400 of FIG. 4 may include at least one additional operation. Additional operations may include an operation 804.

Operation 804 illustrates providing a notification regarding the rate of change of the monetary value of the at least one replaceable battery module. For example, as shown in FIGS. 2 and 3, the notification module 117 may receive one more audio/video signals associated with a rate of change of replaceable battery valuation associated with the replaceable battery module 101 from the processor 109 and broadcast that information to a user. For example, as described above, the replaceable battery valuation system 100 may determine the rate of change of the replaceable battery valuation and provide signals to the notification module 117 causing the notification module 117 to display a graphical indication of the rate of change (e.g. a directional arrow having an orientation corresponding to the rate of change).

Alternately, the processor 109 may cause the network interface device 115 to provide one or more notifications regarding the rate of change of the monetary valuation of the replaceable battery module 101 of the over the network 116. For example, the processor 109 may cause the network interface device 115 to transmit an e-mail to text message to a user's e-mail or text messaging account or post the rate of change of the monetary valuation of the replaceable battery module 101 to a web site accessible by the user.

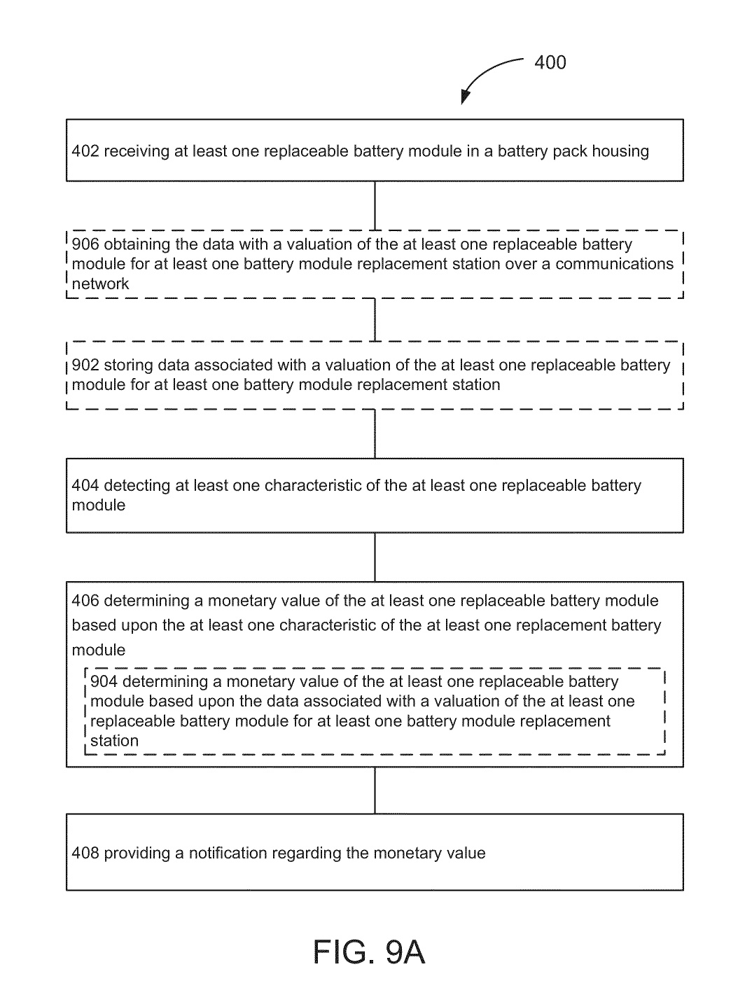

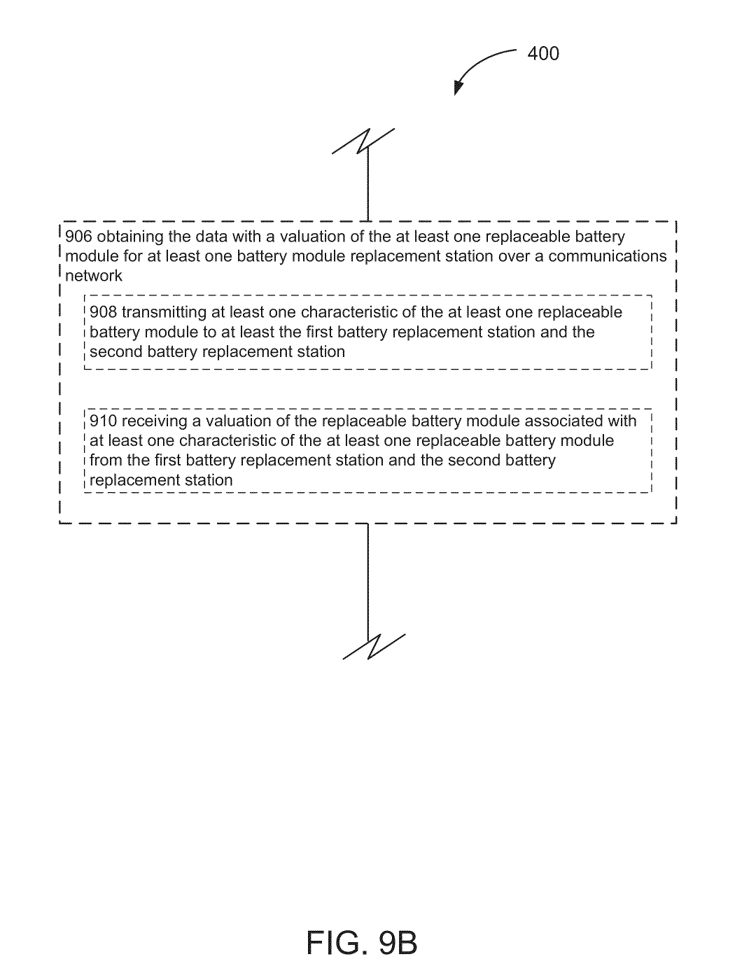

FIG. 9A illustrates an example embodiment where example operational flow 400 of FIG. 4 may include at least one additional operation. Additional operations may include operations 902 and/or 906. Further, FIG. 9 illustrates an example embodiment where operation 406 of the example operational flow 400 of FIG. 4 may include at least one additional operation. Additional operations may include an operation 904.

Operation 902 illustrates storing data associated with a valuation of the at least one replaceable battery module for at least one battery module replacement station. For example, as shown in FIG. 2, a network of battery module replacement stations 118 may be provided which provide battery replacement services to allow a user of a powered device 103 (e.g. a vehicle) to replace/exchange a degraded replaceable battery module 101. The user may receive a credit for the value of the replaceable battery module 101 (determined as described above) from a battery module replacement station 118 to be applied against a cost of a replacement replaceable battery module 101. It may be the case that each of the battery module replacement stations 118 may employ independent battery exchange credit/replacement cost valuation information associated with their battery exchange/replacement services. Such battery exchange/replacement valuation information may be maintained in a battery valuation database 126 associated with each battery module replacement station 118. In order to effectively value a replaceable battery module 101 according to valuation information of those battery module replacement stations 118 in proximity to a powered device 103 employing a replaceable battery module 101 so as to permit a user to choose between the battery module replacement stations 118, the battery valuation information maintained in the battery valuation database 119 of each battery module replacement station 118 may be obtained by the replaceable battery valuation system 100 to enable battery module replacement station 118—specific valuations for a replaceable battery module 101 currently in use.

Operation 904 illustrates determining a monetary value of the at least one replaceable battery module based upon the data associated with a valuation of the at least one replaceable battery module for at least one battery module replacement station. The processor 109 may then carry out replacement battery valuation operations, as described above with respect to Operation 406, with employing battery valuation information for at least one battery module replacement station 118 stored in battery valuation database 119.

Operation 906 illustrates obtaining the data associated with a valuation of the at least one replaceable battery module for at least one battery module replacement station over a communications network. For example, as shown in FIGS. 1 and 2, the replaceable battery valuation system 100 may further include a network interface device 127 (e.g. a wireless communications device employing GSM, GPRS, CDMA, EV-DO, EDGE, WiMAX, LTE and or Wi-fi protocols, and the like) to communicate with a communications network 128 (e.g. the World Wide Web). The network interface device 115 of the replaceable battery valuation system 100 may interface with the network 116 to obtain battery valuation information from the battery valuation database 119 of each battery module replacement station 118. This battery valuation information may be stored to the monetary value database 114 of the replaceable battery valuation system 100.

FIG. 9B illustrates an example embodiment where example operation 906 of operational flow 400 of FIG. 9A may include at least one additional operation. Additional operations may include operations 908 and/or 910.

Operation 908 illustrates transmitting at least one characteristic of the at least one replaceable battery module to at least the first battery replacement station and the second battery replacement station. For example, as shown in FIGS. 1-3, upon detection of at least one characteristic of the replaceable battery module 101 by a sensor 107, the network interface device 115 of the replaceable battery valuation system 100 may interface with the network 116 to transmit the characteristic of the replaceable battery module 101 to battery module replacement station 118A, battery module replacement station 1188 and/or battery module replacement station 118C.

Operation 910 illustrates receiving a valuation of the replaceable battery module associated with at least one characteristic of the at least one replaceable battery module from the first battery replacement station and the second battery replacement station. For example, as shown in FIGS. 1-3, upon receipt of at least one characteristic of the replaceable battery module 101, the battery valuation database 119 of each battery module replacement station 118 may be queried to determine a battery valuation associated with the characteristic of the replaceable battery module 101. The valuation associated with the characteristic of the replaceable battery module 101 may be provided to the replaceable battery valuation system 100 via the network 116 and received by the replaceable battery valuation system 100 via the network interface device 115.

In a further embodiment, the replaceable battery valuation system 100 may conduct a an auction or other price negotiation with one or more battery module replacement stations 118. For example, it may be the case that battery module replacement station 118A offers a $100 valuation for the replaceable battery module 101 while battery module replacement station 118B offers $105 valuation for the replaceable battery module 101. The controller 106 may compare the valuation offers and transmit a negotiation offer to one or more battery module replacement stations 118. For example, the controller 106 may transmit an offer to match or better the $105 offer by battery module replacement station 118B to the battery module replacement station 118A.

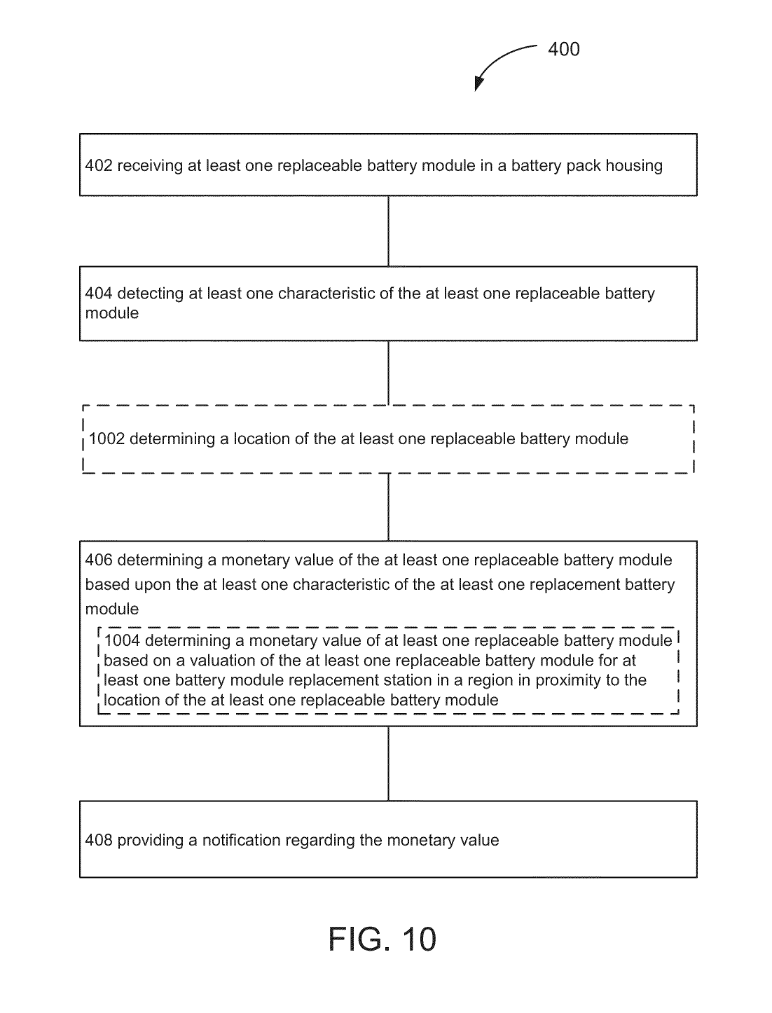

FIG. 10 illustrates an example embodiment where operation 404 of example operational flow 400 of FIG. 4 may include at least one additional operation. Additional operations may include an operation 1002. Further, FIG. 10 illustrates an example embodiment where operation 406 of the example operational flow 400 of FIG. 4 may include at least one additional operation. Additional operations may include an operation 1004.

Operation 1002 illustrates determining a location of the at least one replaceable battery module. For example, as shown in FIGS. 1-2, the replaceable battery valuation system 100 may further include a location awareness device 120 (e.g., a Global Positioning System (GPS) receiver configured to receive a GPS signal from one or more GPS satellites 121). The location awareness device 120 may be configured to determine a location of a powered device 103 employing the replaceable battery module 101 so as to locate one or more battery module replacement stations 118 in proximity to the powered device 103 such that those battery module replacement stations 118 may be provided to a user as potential options for replacement of a degraded replaceable battery module 101. For example, as shown in FIG. 2, the replaceable battery valuation system 100 may determine its location relative to one or more battery module replacement stations 118 using the location awareness device 120.

Operation 1004 illustrates determining a monetary value of at least one replaceable battery module based on a valuation of the at least one replaceable battery module for at least one battery module replacement station in a region in proximity to the location of the at least one replaceable battery module. For example, as shown in FIGS. 1-2, the processor 109 may obtain the location data from the location awareness device 120. Further, the processor 109 may obtain location data associated with various battery module replacement stations 118 (e.g. via network 116). The processor 109 may compare the location data associated with the replaceable battery valuation system 100 and the location data associated with the various battery module replacement stations 118 to determine a relative distance to the battery module replacement stations 118. The battery module replacement stations 118 may be filtered by distance to provide battery valuation information associated with the replaceable battery module 101 only for those battery module replacement stations 118 in proximity to the replaceable battery valuation system 100 (e.g. within a threshold distance from the replaceable battery valuation system 100 as determined from the relative locations of the replaceable battery valuation system 100 and the battery module replacement stations 118).

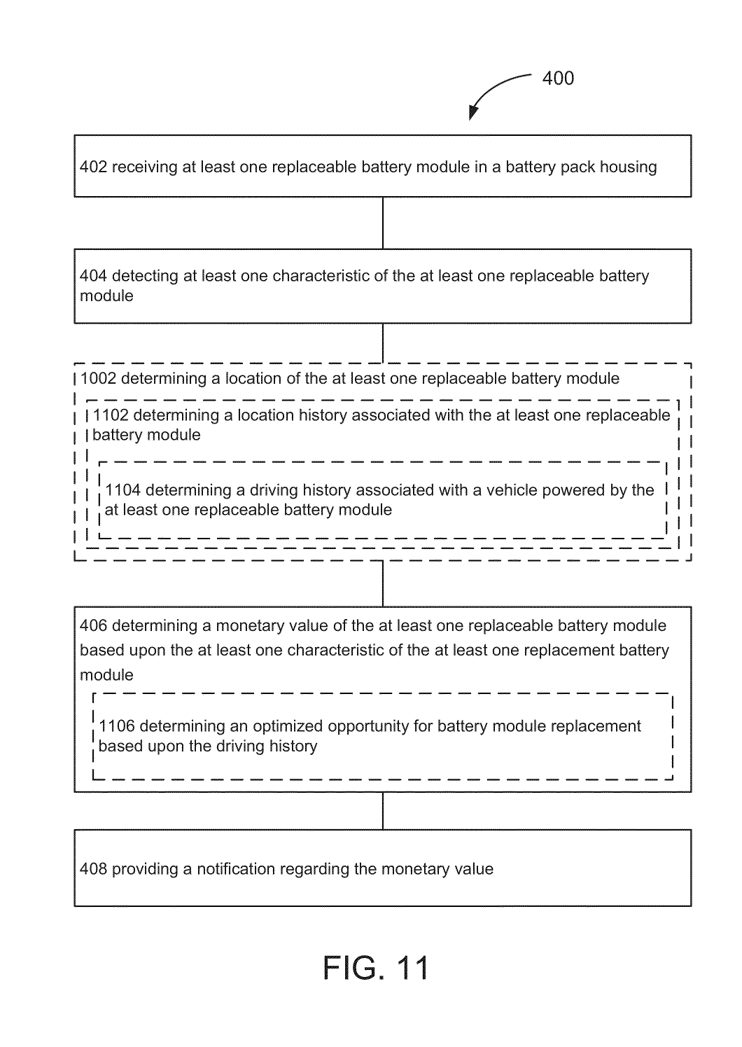

FIG. 11 illustrates an example embodiment where operation 1002 of example operational flow 400 of FIG. 10 may include at least one additional operation. Additional operations may include operations 1102 and/or 1104. Further, FIG. 11 illustrates an example embodiment where operation 406 of the example operational flow 400 of FIG. 4 may include at least one additional operation. Additional operations may include an operation 1106.

Operation 1102 illustrates determining a location history associated with the at least one replaceable battery module. For example, the replaceable battery valuation system 100 may maintain a location history database 122. The location history database 122 may be configured to store historical location data as determined by the location awareness device 120 over a period of time. The processor 109 may periodically retrieve the historical location data and analyze the data for trends in the location history.

Operation 1104 illustrates determining a driving history associated with a vehicle powered by the at least one replaceable battery module. For example, the replaceable battery module 101 may be employed in powered device 103 such as an automobile. The location history database 122 may be configured to store historical driving data as determined by the location awareness device 120 over a period of time. The processor 109 may periodically retrieve the historical driving data and analyze the data for trends in the location history. For example, it may be the case that a user drives their vehicle along the same route to work Monday through Friday.

Operation 1106 illustrates determining an optimized opportunity for battery module replacement based upon the driving history. For example, as shown in FIGS. 1-3, there may be multiple battery module replacement stations 118 along a historical driving route, each battery module replacement stations 118 having varying battery replacement/exchange valuation information. The processor 109 may determine that on a given day, a particular battery module replacement station 118 may have lower replacement pricing and/or higher exchange credits than other battery module replacement stations 118. Based on the a priori knowledge of the historical location data and the current battery replacement/exchange valuation information, the replaceable battery valuation system 100 may provide a predictive recommendation as to a specific battery module replacement station 118 that should be used for replacement of the replaceable battery module 101 when a characteristic of the replaceable battery module 101 indicates that replacement is needed (e.g. detection of a threshold level of degradation of the replaceable battery module 101 by a sensor 107).

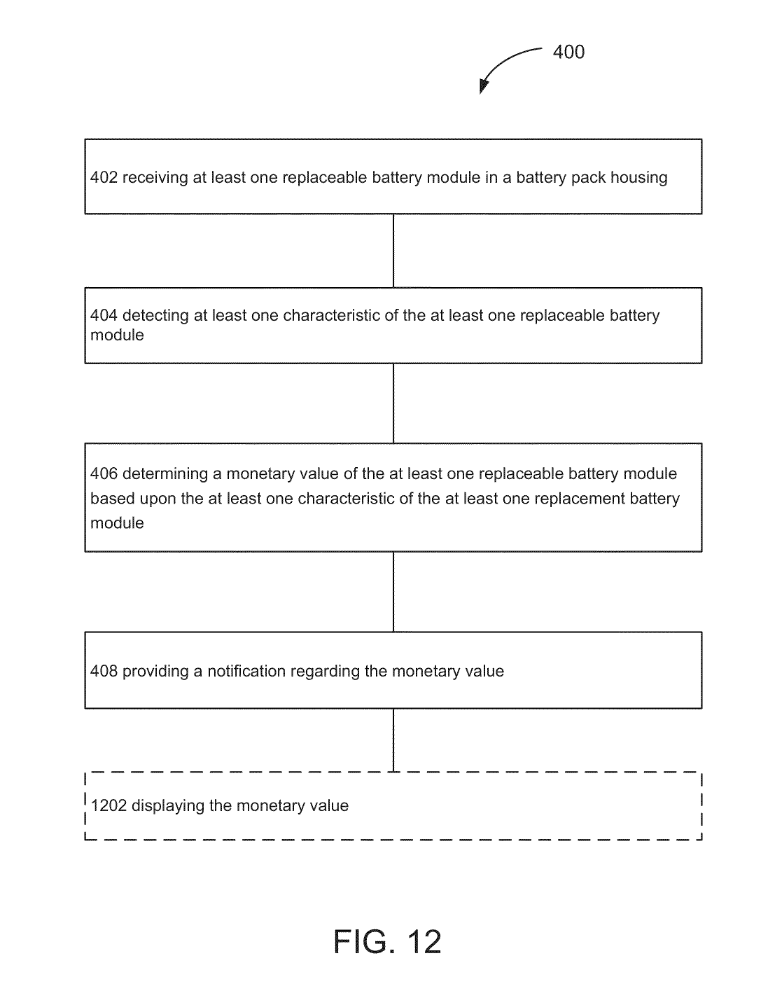

FIG. 12 illustrates an example embodiment where example operational flow 400 of FIG. 4 may include at least one additional operation. Additional operations may include an operation 1202.

Operation 1202 illustrates displaying the monetary value. For example, as shown in FIGS. 2 and 3, the replaceable battery valuation system 100 may include the notification module 117 (e.g. an audio/video interface device such as a LCD monitor/touch screen). The notification module 117 may receive one more audio/video signals associated with replaceable battery valuation information associated with the replaceable battery module 101 from the processor 109 and broadcast that information to a user. For example, described above, the replaceable battery valuation system 100 may determine its location relative to one or more battery module replacement stations 118. The processor 109 may access a maps database (not shown) and provide signals to the notification module 117 causing the notification module 117 to display a graphical map including indicators associated with the locations of the replaceable battery valuation system 100 and the battery module replacement stations 118. In addition to the location of the battery module replacement stations 118, the notification module 117 may display battery replacement valuation information associated with each battery module replacement station 118 (e.g. as a call-out icon associated with the location of each battery module replacement station 118.)

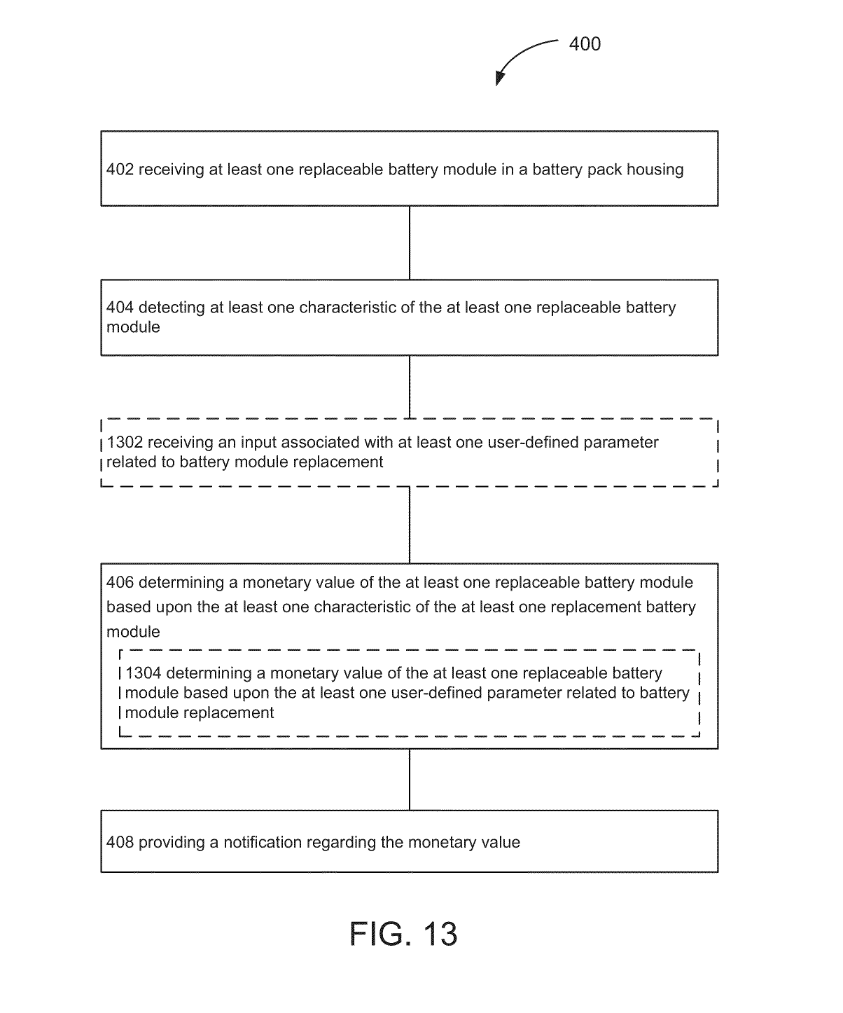

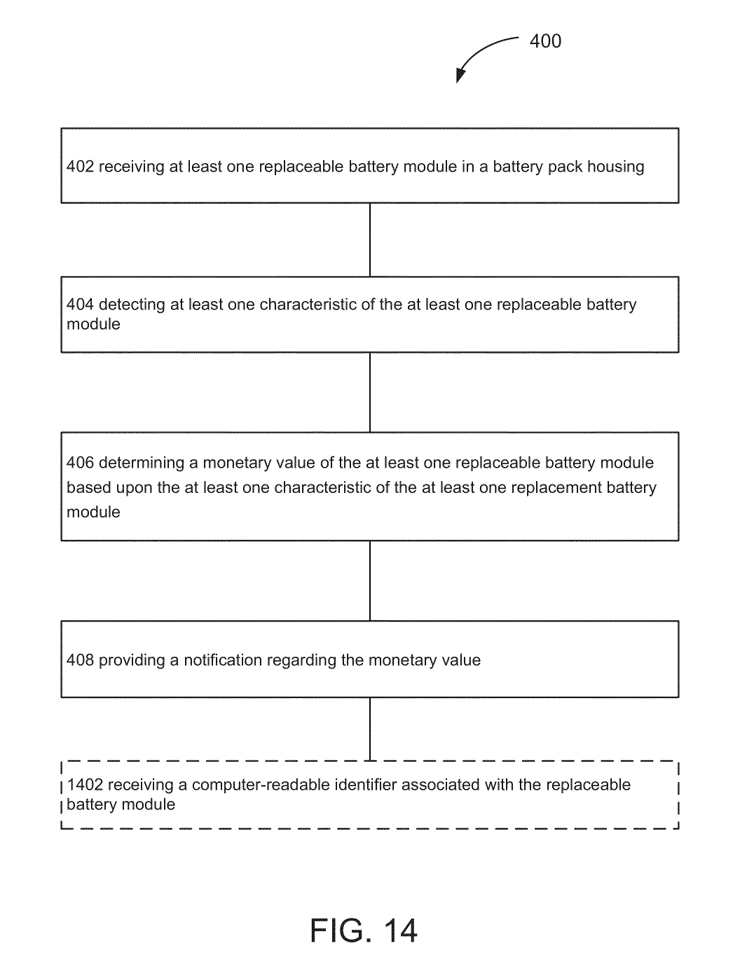

FIG. 13 illustrates an example embodiment where example operational flow 400 of FIG. 4 may include at least one additional operation. Additional operations may include an operation 1302. Further, FIG. 12 illustrates an example embodiment where operation 406 of the example operational flow 400 of FIG. 4 may include at least one additional operation. Additional operations may include an operation 1304.

Operation 1302 illustrates receiving an input associated with at least one user-defined parameter related to battery module replacement. For example, the replaceable battery valuation system 100 may include a user input device 123 (e.g. a keyboard, mouse, touch-screen, etc). The user input device 123 may be configured to receive one or more user inputs associated with one or more user-defined parameters related to replacement of the replaceable battery module 101.

Operation 1304 illustrates determining a monetary value of the at least one replaceable battery module based upon the at least one user-defined parameter related to battery module replacement. For example, as shown in FIGS. 1-3, a user may provide one or more inputs designating an intended route for a vehicle employing the replaceable battery valuation system 100. The processor 109 may obtain location and battery replacement valuation information associated with the battery module replacement stations 118 (as described above) along the user-inputted route and compute an optimized opportunity for replacement of the replaceable battery module 101 along that route based on the characteristics of the replaceable battery module 101.

FIG. 13 illustrates an example embodiment where example operational flow 400 of FIG. 4 may include at least one additional operation. Additional operations may include an operation 1402.

Operation 1402 illustrates receiving a computer-readable identifier associated with the replaceable battery module. For example, as shown in FIG. 1, the replaceable battery module 101 may include a battery identifier 124 (e.g. a bar code, radio frequency identifier, flash chip, etc.) associated with a class of replaceable battery modules 101 and/or a single replaceable battery module 101. When the replaceable battery module 101 is received within the replaceable battery module compartment 102, the processor 109 may interface with the battery identifier 124 (e.g. optically scan a bar code, wirelessly query an RFID, receive a signal associated with a stored identifier) to obtain battery identification information stored by the battery identifier 124. The battery identification information may include information generic to a set of replaceable battery modules 101 including, but not limited to, battery type information, battery configuration information, battery manufacturer information, battery model number, and the like. The battery identification information may include information specific to a single replaceable battery module 101 including, but not limited to, a globally unique identifier (e.g. a serial number), manufacture date, certification data, and the like.

Those having skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.).

In a general sense, those skilled in the art will recognize that the various aspects described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment). Those having skill in the art will recognize that the subject matter described herein may be implemented in an analog or digital fashion or some combination thereof.

Those having skill in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.).

In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. Furthermore, it is to be understood that the invention is defined by the appended claims.

What is claimed:

1. A replaceable battery valuation system, comprising:
at least one replaceable battery module;
at least one sensor configured to measure at least one characteristic of the at least one replaceable battery module; and
a controller configured to:
determine a monetary value of at least one replaceable battery module based upon sensor data regarding the at least one characteristic of the at least one replaceable battery module; and
provide a notification regarding the monetary value.

2. The replaceable battery valuation system of claim 1, further comprising:
a replaceable battery module housing configured to receive the at least one replaceable battery module.

3. The replaceable battery valuation system of claim 1, wherein the at least one sensor configured to measure at least one characteristic of the at least one replaceable battery module further comprises:
at least one sensor configured to measure an energy storage level of the at least one replaceable battery module.

4. The replaceable battery valuation system of claim 1, wherein the at least one sensor configured to measure at least one characteristic of the at least one replaceable battery module further comprising:
at least one memory element configured to store a number of previously occurred charge cycles of the at least one replaceable battery module detected by the sensor.

5. The replaceable battery valuation system of claim 1, wherein the at least one sensor configured to measure at least one characteristic of the at least one replaceable battery module further comprises:
at least one sensor configured to measure a recharge capacity of at least one replaceable battery module.

6. The replaceable battery valuation system of claim 1, wherein the controller configured to determine a monetary value of at least one replaceable battery module based upon sensor data regarding the at least one characteristic of the at least one replaceable battery module comprises:
a controller configured to determine a rate of change of monetary value of the at least one replaceable battery module based upon the data regarding the at least one characteristic of the at least one replaceable battery module.

7. The replaceable battery valuation system of claim 1, further comprising:
a memory configured for storage of data associated with a valuation of the at least one replaceable battery module for at least one battery module replacement station.

8. The replaceable battery valuation system of claim 7, wherein the controller configured to determine a monetary value of at least one replaceable battery module based upon sensor data regarding the at least one characteristic of the at least one replaceable battery module comprises:
a controller configured to determine a monetary value of the at least one replaceable battery module based upon the data regarding the at least one characteristic of the at least one replaceable battery module and the current valuation of the at least one battery module replacement station.

9. The replaceable battery valuation system of claim 1, further comprising:
a network interface device communicatively coupled to the controller.

10. The replaceable battery valuation system of claim 9, wherein the network interface device communicatively coupled to the controller is configured to connect to a communications network.

11. The replaceable battery valuation system of claim 10, wherein the communications network provides access to the Internet.

12. The replaceable battery valuation system of claim 9, wherein the network interface device is configured to access remotely stored information regarding a valuation for at least one battery module replacement station.

13. The replaceable battery valuation system of claim 1, further comprising:
a location awareness device communicatively coupled to the controller.

14. The replaceable battery valuation system of claim 13, wherein the location awareness device further comprises:
a global positioning system receiver.

15. The replaceable battery valuation system of claim 13, wherein the controller configured to determine a monetary value of at least one replaceable battery module based upon sensor data regarding the at least one characteristic of the at least one replaceable battery module comprises:
a controller configured to determine a monetary value of at least one replaceable battery module based upon the data regarding the at least one characteristic of the at least one replaceable battery module and a valuation of the one replaceable battery module for at least one battery module replacement station in a region in proximity to a current location.

16. The replaceable battery valuation system of claim 13, wherein the controller configured to determine a monetary value of at least one replaceable battery module based upon sensor data regarding the at least one characteristic of the at least one replaceable battery module further comprises:
a controller configured to determine a location history associated with the replaceable battery module.

17. The replaceable battery valuation system of claim 16, wherein the location history associated with the replaceable battery module comprises:
a driving history associated with a vehicle powered by the replaceable battery module.

18. The replaceable battery valuation system of claim 17, wherein the controller configured to determine a driving history further comprises:
a controller configured to determine an optimized opportunity for battery module replacement based upon the driving history and the at least one characteristic of the at least one replacement battery module.

19. The replaceable battery valuation system of claim 7, wherein the controller configured to determine a monetary value of at least one replaceable battery module based upon sensor data regarding the at least one characteristic of the at least one replaceable battery module comprises:
a controller configured to determine a first monetary value based upon a first valuation from a first battery module replacement station and a second monetary value based upon a second valuation from a second battery module replacement station.

20. The replaceable battery valuation system of claim 7, wherein the controller configured to determine a monetary value of at least one replaceable battery module based upon sensor data regarding the at least one characteristic of the at least one replaceable battery module comprises:
transmit at least one characteristic of the at least one replaceable battery module to at least the first battery replacement station and the second battery replacement station; and
receive a valuation of the replaceable battery module associated with at least one characteristic of the at least one replaceable battery module from the first battery replacement station and the second battery replacement station.

21. The replaceable battery valuation system of claim 1, further comprising a display.

22. The replaceable battery valuation system of claim 21, wherein the display is configured for presentation of a map image including a first battery module replacement station and a second battery module replacement station.

23. The replaceable battery valuation system of claim 21, wherein the display is configured to present the notification regarding the monetary value.

24. The method for replaceable battery valuation of claim 23, wherein the display is configured to present the notification regarding the rate of change of the monetary value of the at least one replaceable battery module.

25. The replaceable battery valuation system of claim 1, wherein the controller configured to determine a monetary value of the at least one replaceable battery module based upon the data regarding the at least one characteristic of the at least one replaceable battery module further comprises:
a controller configured to receive at least one user-defined parameter related to battery module replacement.

26. The replaceable battery valuation system of claim 25, wherein the controller configured to receive at least one user-defined parameter related to battery module replacement further comprises:
a controller configured to determine an optimized opportunity for battery replacement based upon the user-defined parameter, a current location and a current valuation of the at least one battery module for the at least one battery module replacement station.

27. The replaceable battery valuation system of claim 1, wherein the system further comprises:
a means for reading out a computer-readable identifier associated with the replaceable battery module.

28. The replaceable battery valuation system of claim 27, wherein the computer-readable identifier associated with the replaceable battery module comprises:
a globally unique computer-readable identifier associated with the replaceable battery module.

29. The replaceable battery valuation system of claim 27, further comprising:
means for digital communications with a battery controller associated with the replaceable battery module.

30. A method for replaceable battery valuation of claim, comprising:
receiving at least one replaceable battery module in a battery pack housing;
detecting at least one characteristic of the at least one replaceable battery module;
determining a monetary value of the at least one replaceable battery module based upon the at least one characteristic of the at least one replacement battery module; and
providing a notification regarding the monetary value of the at least one replaceable battery module.

31. The method for replaceable battery valuation of claim 30, wherein the detecting at least one characteristic of the at least one replaceable battery module comprises:
detecting an energy storage level of the at least one replaceable battery module.

32. The method for replaceable battery valuation of claim 30, wherein the detecting at least one characteristic of the at least one replaceable battery module comprises:
detecting at least one charging cycle of the at least one replaceable battery module; and
storing data associated with a detected charging cycle of the at least one replaceable battery module.

33. The method for replaceable battery valuation of claim 32, wherein the determining a monetary value of the at least one replaceable battery module based upon the at least one characteristic of the at least one replacement battery module comprises:
determining a monetary value of the at least one replaceable battery module based upon a number of detected charging cycles for the at least one replacement battery module.

34. The method for replaceable battery valuation of claim 30, wherein the detecting at least one characteristic of the at least one replaceable battery module comprises:
detecting a recharge capacity of the at least one replaceable battery module.

35. The method for replaceable battery valuation of claim 30, wherein the determining a monetary value of the at least one replaceable battery module based upon the at least one characteristic of the at least one replacement battery module comprises:
determining a rate of change of the monetary value of the at least one replaceable battery module based upon the at least one characteristic of the at least one replacement battery module.

36. The method for replaceable battery valuation of claim 30, wherein the providing a notification regarding the monetary value of the at least one replaceable battery module comprises:
providing a notification regarding the rate of change of the monetary value of the at least one replaceable battery module.

37. The method for replaceable battery valuation of claim 30, further comprising:
storing data associated with a valuation of the at least one replaceable battery module for at least one battery module replacement station.

38. The method for replaceable battery valuation of claim 37, wherein the determining a monetary value of the at least one replaceable battery module based upon the at least one characteristic of the at least one replacement battery module further comprises:
determining a monetary value of the at least one replaceable battery module based upon the data associated with a valuation of the at least one replaceable battery module for at least one battery module replacement station.

39. The method for replaceable battery valuation of claim 37, further comprising:
obtaining the data associated with a valuation of the at least one replaceable battery module for at least one battery module replacement station over a communications network.

40. The method for replaceable battery valuation of claim 39, wherein the obtaining the data associated with a valuation of the at least one replaceable battery module for at least one battery module replacement station over a communications network further comprises:
transmitting at least one characteristic of the at least one replaceable battery module to at least the first battery replacement station and the second battery replacement station; and
receiving a valuation of the replaceable battery module associated with at least one characteristic of the at least one replaceable battery module from the first battery replacement station and the second battery replacement station.

41. The method for replaceable battery valuation of claim 30, further comprising:
determining a location of the at least one replaceable battery module.

42. The method for replaceable battery valuation of claim 41, wherein the determining a monetary value of the at least one replaceable battery module based upon the at least one characteristic of the at least one replacement battery module further comprises:
determining a monetary value of at least one replaceable battery module based on a valuation of the at least one replaceable battery module for at least one battery module replacement station in a region in proximity to the location of the at least one replaceable battery module.

43. The method for replaceable battery valuation of claim 41, wherein the determining a location of the at least one replaceable battery module comprises:
determining a location history associated with the at least one replaceable battery module.

44. The method for replaceable battery valuation of claim 43, wherein the determining a location history associated with the at least one replaceable battery module comprises:
determining a driving history associated with a vehicle powered by the at least one replaceable battery module.

45. The method for replaceable battery valuation of claim 44, wherein the determining a monetary value of the at least one replaceable battery module based upon the at least one characteristic of the at least one replacement battery module comprises:
determining an optimized opportunity for battery module replacement based upon the driving history.

46. The method for replaceable battery valuation of claim 30, wherein the providing a notification regarding the monetary value of the at least one replaceable battery module comprises:
displaying the monetary value.

47. The method for replaceable battery valuation of claim 30, further comprising:
receiving an input associated with at least one user-defined parameter related to battery module replacement.

48. The method for replaceable battery valuation of claim 47, wherein the determining a monetary value of the at least one replaceable battery module based upon the at least one characteristic of the at least one replacement battery module comprises:
determining a monetary value of the at least one replaceable battery module based upon the at least one user-defined parameter related to battery module replacement.

49. The method for replaceable battery valuation of claim 30, further comprising:
receiving a computer-readable identifier associated with the replaceable battery module.
